(19) United States
(12) Patent Application Publication
(10) Pub. No.: US 2009/0026414 A1
(43) Pub. Date: Jan. 29, 2009

(54) Process for the production of an aqueous stream comprising melamine and aldehyde

(76) Inventors: Nora A. Wit De, Voerendaal (NL); Hendrik D. Hoving, Maastricht (NL); Henricus A.M. Duisters, Budel (NL); Hendrinus M. Verschoor, Klimmen (NL)

Correspondence Address: NIXON & VANDERHYE, PC, 901 NORTH GLEBE ROAD, 11TH FLOOR, ARLINGTON, VA, 22203, US

(21) Appl. No.: 11/665,154

(22) PCT Filed: Sep. 30, 2005
(86) PCT No.: PCT/NL05/00712

§ 371 Date: Apr. 12, 2007

(30) Foreign Application Priority Data
Oct. 22, 2004 (NL) 1027314

(51) Int. Cl. C09K 3/00

(52) U.S. Cl. 252/182.23

(57) ABSTRACT

Process for the production of an aqueous stream comprising melamine and aldehyde in which a melamine comprising aqueous stream is contacted with an aldehyde comprising stream, the melamine comprising aqueous stream originating from a melamine plant, and process for the production of an aqueous stream comprising melamine, urea and aldehyde in which a melamine comprising aqueous stream and a urea comprising stream are being contacted with an aldehyde comprising stream, the melamine comprising aqueous stream originating from a melamine plant.

The invention relates to a process for the production of an aqueous stream comprising melamine and aldehyde or a process for the production of an aqueous stream comprising melamine, urea and aldehyde. Nowadays, such a stream, which is also known as melamine-formaldehyde precondensate (MF) or melamine-urea-formaldehyde precondensate (MUF), is used on a limited scale as starting material in the production of MF and MUF resins.

According to the state of the art MF and MUF resins are produced on the basis of solid melamine and urea granulate or urea prills and an aqueous formaldehyde solution. These starting materials are often transported over long distances to the resins plant. During the transport of the aqueous formaldehyde solution the required safety measures are to be observed and, in case of an incident, the environment may be endangered. For this reason resins plants are often situated in the vicinity of a formaldehyde plant. To be able to produce a resin the solid melamine and, optionally, the urea granulate or the urea prills are dissolved in water and/or in an aqueous formaldehyde solution.

A drawback of the process according to the state of the art is that solid melamine is to be produced, with water being removed from the melamine at high cost and with a great deal of attention being paid to the particle-size distribution of the melamine during melamine recrystallization. The solid melamine is subsequently transported to the resins plant, where the melamine must be redissolved in water in order to be able to produce the resin.

It is the aim of the invention to eliminate this drawback.

This aim is achieved in that a melamine comprising aqueous stream is contacted with an aldehyde comprising stream, the melamine comprising aqueous stream originating from a melamine plant. This aim is also achieved in that a melamine comprising aqueous stream and a urea comprising stream are contacted with an aldehyde comprising stream, the melamine comprising aqueous stream originating from a melamine plant.

Such a way of preparing an aqueous stream comprising melamine and aldehyde or an aqueous stream comprising melamine, urea and aldehyde does away with the need to separate the water from the melamine comprising aqueous stream in order to form solid melamine.
There is no longer any need for recrystallization of the melamine to obtain melamine with a higher purity and with a specific particle-size distribution, either. This allows major savings to be achieved in terms of energy, capital investments and labour costs.

Another advantage of the process according to the invention is that the aqueous stream comprising melamine and aldehyde and the aqueous stream comprising melamine, urea and aldehyde are stable over a long period of time and can be transported over large distances without any safety and environmental hazards.

A further advantage is that in this way it is economically feasible to produce large volumes of the aqueous stream comprising melamine and aldehyde or the aqueous stream comprising melamine, urea and aldehyde, so that such streams become available as starting material for the production of MF and MUF resins.

An aqueous stream comprising melamine and aldehyde or an aqueous stream comprising melamine, urea and aldehyde is a precondensate. A precondensate is an aqueous solution that comprises melamine, an aldehyde and, optionally, urea in a free and/or dissolved and/or reacted form. An aqueous stream comprising melamine and aldehyde or an aqueous stream comprising melamine, urea and aldehyde has a low viscosity that makes it possible to store these products in tanks and transport them by means of a pump.

The melamine comprising aqueous stream originates from a melamine plant. A melamine plant comprises a reaction section comprising a reactor, a quench and a stripper, followed by a recovery section where the melamine is purified from by-products.

The melamine comprising aqueous stream can for instance be separated immediately downstream of the melamine reactor, but it is also possible to separate the melamine comprising aqueous stream further downstream in the process. Preferably the melamine comprising aqueous stream is separated from the plant downstream of the stripper. As a result of the separation, the pressure of the melamine comprising aqueous stream decreases and the stream is subsequently used for the production of the precondensate.
It is possible to combine several streams coming from various places in the melamine plant downstream of the reactor into a single stream. Likewise it is possible to use all melamine or only a part of the amount of melamine produced in the melamine plant as melamine comprising aqueous stream.
Preferably the melamine comprising aqueous stream amounts to more than 5 wt. % of the total stream leaving the reactor, more preferably to more than 10 wt. % and with particular preference to more than 20 wt. %.

Preferably the melamine-comprising aqueous stream amounts to less than 95 wt. % of the total stream leaving the reactor, more preferably to less than 75 wt. % and with particular preference to less than 50 wt. %.

Assuming that at least a part of all melamine produced does not pass through all downstream steps in, for instance, the recovery section to obtain pure melamine, the process according to the invention provides a possibility for optimization of a melamine plant, without the capacity of all parts of the melamine synthesis section and the recovery section having to be increased.

The aqueous stream comprising melamine preferably comprises between 5 and 50 wt. % water, with particular preference between 10 and 25 wt. % water. Water can be added to or removed from the aqueous stream comprising melamine.

The melamine comprising aqueous stream is preferably purified, but this is not necessary for the use of this stream for the production of the precondensate. Purification takes place in order to obtain a precondensate that meets the specifications for resin preparation. Purification can take place before the preparation of the precondensate, but it is also possible to purify the precondensate itself. Purification of the melamine comprising aqueous stream or the precondensate can for instance take place by passing the melamine comprising aqueous stream over a filter, hydrocyclone or centrifuge and/or washing it with, for instance, water. This for instance results in removal of melamine by-products, such as for instance urea, guanidine, CO₂, NH₃, melam and melem. Catalyst residues, if the melamine is obtained in a catalytic melamine production process, can, if desired, for instance be removed by filtering the precondensate.

As aldehyde the aldehyde comprising stream for instance comprises formaldehyde, furfural and/or glyoxal. Preferably the aldehyde comprising stream comprises formaldehyde.

The formaldehyde comprising stream may be gaseous, but may for instance also be a solution of formaldehyde in water or methanol. The formaldehyde comprising stream may essentially consist of formaldehyde, such as for instance in the case of a gaseous stream of almost pure formaldehyde from a formaldehyde plant, but this is not necessary, as in the example of an aqueous solution of formaldehyde, usually called formalin. In practice formalin often comprises between 20 wt. % and 60 wt. % formaldehyde and between 0 wt. % and 15 wt. % methanol.

In a preferred embodiment of the invention the formaldehyde comprising stream is gaseous and comes from a formaldehyde plant, where formaldehyde is prepared in a known way, which is often done with methanol as raw material in a catalyzed reaction. This has the advantage that the formaldehyde comprising stream can be contacted according to the invention with the melamine comprising aqueous stream and, optionally, the urea comprising stream directly upon leaving the formaldehyde plant.

When, besides the melamine comprising aqueous stream and the aldehyde comprising stream, use is also made of a urea comprising stream for the preparation of an aqueous stream comprising melamine, urea and aldehyde, the urea comprising stream may be solid urea (granulated or prilled) or a urea comprising aqueous stream. The solid urea can be mixed with the melamine comprising aqueous stream in order to be dissolved and thus to obtain a reaction mixture that can form a precondensate. The urea comprising aqueous stream can be prepared from solid urea or can be separated from a urea plant.

A urea plant comprises a synthesis section and one or more recovery sections, followed by an evaporation section and granulation or prilling section. A synthesis section is a section in which NH₃ and CO₂ are converted into urea at high pressure and temperature. Water is liberated in this reaction. The stream leaving the synthesis section is the synthesis solution, which, besides urea and water, may also contain NH₃, CO₂ and carbamate. If it is the aim, as hitherto customary, to obtain pure, solid urea, then the synthesis solution is subjected to several further steps in the recovery section(s), the evaporation section and then solid urea is formed by means of granulation or prilling, It is a further advantage of the invention to separate the urea comprising aqueous stream directly from a urea plant, because in this way the urea comprising stream does not have to pass the evaportion section and the granulation or prilling section in the urea plant, allowing further savings in energy, capital investments and labour costs.

If a urea comprising aqueous stream is separated from a urea plant, then this is for instance the synthesis solution or one of the aqueous urea streams that are formed in the recovery section. It is possible to combine several streams coming from several places in the urea plant downstream of the synthesis section into one single stream. Likewise it is possible to use all the urea or only a part of the urea quantity produced in the urea plant as urea comprising stream.

Preferably the urea comprising stream is less than 20 wt. % of the total stream leaving the reactor, more preferably less than 10 wt. % and with particular preference less than 5 wt. %.

Assuming that at least a part of all urea produced does not pass through all further steps in, for instance, the recovery section to obtain pure urea, the process according to the invention provides a possibility for optimization of a urea plant, without the capacity of all parts of the urea synthesis section and the recovery section having to be increased.

Preferably the water content of the urea comprising stream is higher than 5% and lower than 50%. Water can be added to or removed from the urea comprising stream.

Combination of the melamine comprising aqueous stream, optionally the urea comprising stream, and the formaldehyde comprising stream can be effected in a plant, for the preparation of an aqueous stream comprising melamine and formaldehyde or an aqueous stream comprising melamine, urea and formaldehyde, comprising a melamine synthesis section in which a melamine comprising aqueous stream is formed and optionally a recovery section, in which the melamine is purified, the plant comprising a combination section in which the melamine comprising aqueous stream is contacted with a formaldehyde comprising stream and optionally a urea comprising stream, so that the aqueous stream comprising melamine and formaldehyde is formed or the aqueous stream comprising melamine, urea and formaldehyde is formed, and means for the transport of the formaldehyde comprising stream and, optionally, the urea comprising stream to a combination section and for the transport of the melamine comprising aqueous stream from the melamine plant to the combination section.

The plant may also comprise a urea synthesis section, in which a urea comprising stream is formed, and optionally a recovery section in which compounds other than urea are removed wholly or in part from the urea comprising stream, with the urea comprising stream that is added to the combination section originating from the urea synthesis section.

In the combination section the melamine comprising aqueous stream, optionally the urea comprising stream and the formaldehyde comprising stream are contacted with each other, so that a MF or MUF precondensate is formed. This is, to a greater or lesser extent, accompanied by a reaction, usually a condensation reaction, between melamine, formaldehyde and optionally urea. The said reaction generally proceeds spontaneously. For this reason many methods and conditions are suitable for use in the combination section. As a rule no special catalyst is needed. The combination step can be carried out batchwise as well as continuously. The combination step can be carried out at atmospheric pressure, but optionally also at elevated or reduced pressure. For economic considerations an atmospheric pressure will usually be chosen. The temperature during the combination step may vary within wide limits, and usually lies between 50° C. and 150° C.; preferably the temperature lies between 60° C. and 140° C., more preferably between 70° C. and 120° C.

In the aqueous stream comprising melamine and aldehyde, that is formed according to the process of the invention, the molar ratio between formaldehyde and melamine (F/M ratio) preferably lies between 0.5 and 20.0, with particular preference between 1.5 and 12.0.

In the aqueous stream comprising melamine, urea and formaldehyde the molar ratio between formaldehyde, urea and melamine (expressed in the ratio F/(NH₂)₂) preferably lies between 0.5 and 5.0, with particular preference 1.0-3.0.

The aqueous stream comprising melamine and formaldehyde or the aqueous stream comprising melamine, urea and formaldehyde comprises a molar excess of formaldehyde relative to the amount of melamine and optionally urea. This ensures that these streams remain stable over a long period and are suitable for the transport over large distances. The aqueous stream comprising melamine and formaldehyde and the aqueous stream comprising melamine, urea and formaldehyde may contain traces of other components. Examples of such components are starting compounds that have not reacted, by-products of the formaldehyde synthesis or of the preparation of urea or melamine, but also additives. Examples of such additives are alcohols, amines, amino alcohols and other organic and inorganic compounds. It is possible to convert the aqueous stream comprising melamine and formaldehyde or the aqueous stream comprising melamine, urea and formaldehyde into a solid substance, for instance by means of spray drying. This solid substance is stable for an even longer period than the aqueous stream.

If the formaldehyde comprising stream is gaseous, the combination step can for instance be carried out by passing the formaldehyde comprising stream through the melamine comprising aqueous stream and/or a urea comprising aqueous stream, in for instance a vessel or an absorption column. Such an absorption column is used in known processes for the preparation of formaldehyde, in order to prepare formalin from a stream of gaseous formaldehyde with the aid of water. In an embodiment of the invention it is possible to perform the combination step in a process for the preparation of formaldehyde which comprises an absorption column, by feeding the melamine comprising aqueous stream from the melamine plant and, optionally, a urea comprising stream to the absorption column rather than water.

If the total amount of water in the melamine comprising aqueous stream and/or the urea comprising aqueous stream is not enough for the desired application, an aqueous stream is advantageously supplied to the combination section; it is also possible to supply water to or to remove water from the MF or MUF precondensate already formed.

The MF or MUF precondensate thus formed can be applied in many different ways. Examples are as or in MF resin or MUF resin, or as or in MF or MUF adhesive. In these applications it may be necessary, if a molar excess of formaldehyde is present in the MF or MUF, to supply melamine and/or urea to the precondensate. This causes the F/M ratio to decrease, so that in this way for instance an MF resin or MF adhesive can be made from an MF precondensate. These steps are known to one skilled in the art.

The invention will be elucidated on the basis of two figures and examples, without being limited thereto.

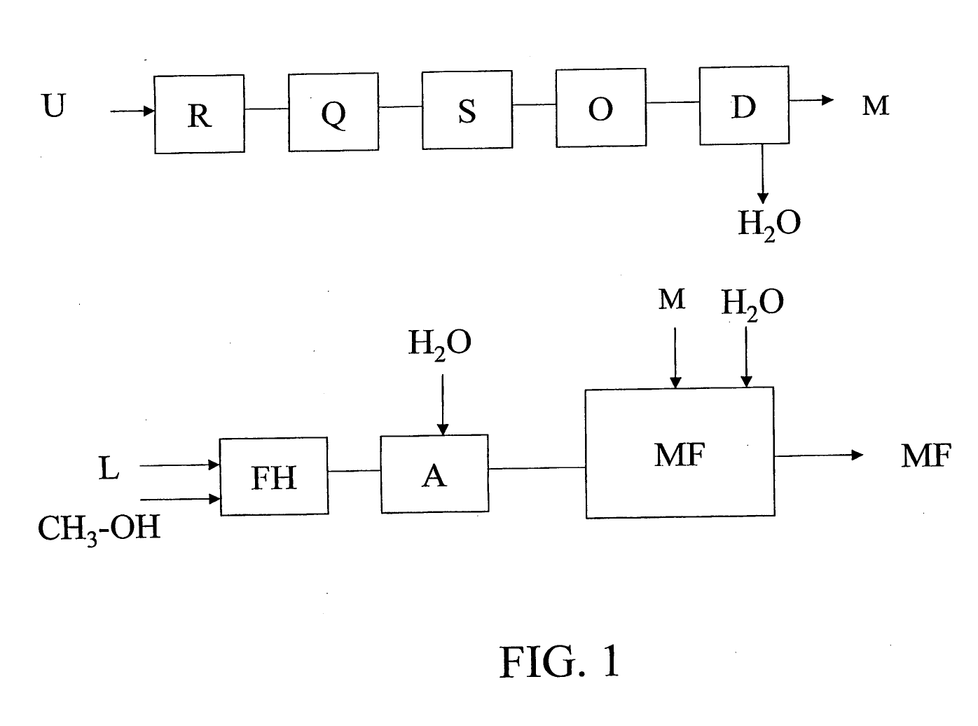

FIG. 1 describes a process for the production of an MF resin according to the state of the art. Melamine is produced in a melamine plant at a different location from the location of the MF resins plant. Melamine (M) is produced by the addition of urea (U) to a melamine reactor (R) in a melamine plant. The melamine plant further comprises a quench (Q), a stripper (S), a recovery section (O) and a dryer (D). The melamine plant produces solid melamine that is stored and transported. At the same location as the location of the MF resins plant there is a formaldehyde plant, comprising a synthesis section (FH) and an absorption section (A). In the synthesis section air (L) and methanol are introduced and formaldehyde is formed at a high temperature with the aid of a catalyst.

The formaldehyde is then transported to the absorption section, where the gaseous formaldehyde is absorbed into water. This formaldehyde solution is then dosed to an MF resin plant. The melamine needed for the preparation of the resin is supplied by means of transport from the melamine plant over a large distance and the solid melamine is first dissolved in water. This aqueous melamine solution is then dosed to the resin plant for the preparation of an MF resin (MF).

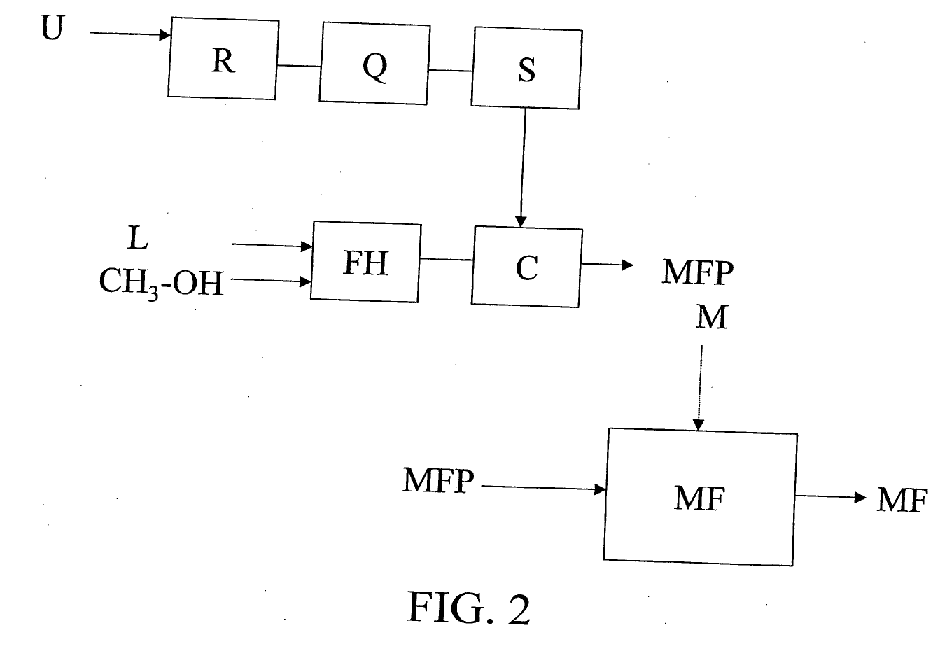

FIG. 2 describes a process for the production of an MF resin (MF) from an MF precondensate (MFP) according to the invention as starting material. The location of the resin plant is different from the location of the melamine plant and the formaldehyde plant that are needed for the production of the MF precondensate. The MF precondensate is transported to the location where the MF resin is prepared. Optionally also solid melamine (M) or dissolved solid melamine is added to the MF resins plant. Melamine is produced by the addition of urea (U) to a melamine reactor (R) in a melamine plant. The melamine plant further comprises a quench (Q) and a stripper (S). The melamine comprising aqueous stream obtained after the stripper is dosed to the combination section (C) according to the invention. In the formaldehyde plant, comprising a synthesis section (FH), formaldehyde is produced at a high temperature with the aid of a catalyst. The formed formaldehyde gas is also added to the combination section according to the invention, where it is absorbed into the melamine comprising aqueous stream, which results in the formation of the MF precondensate (MFP).

### EXAMPLE I

For the preparation of an MF precondensate 497 g of a formaldehyde comprising stream was added to a 2.0 L reactor. The pH of the formaldehyde comprising stream was set at 8.5 using NaOH and 466 g of a melamine comprising aqueous stream was added.

The melamine comprising aqueous stream was separated directly after the stripper of a melamine plant.
The melamine comprising aqueous stream comprised 79 wt. % melamine and 21 wt. % water and the formaldehyde comprising stream comprised 30 wt. % formaldehyde and 70 wt. % water.
Subsequently the pH was brought back to 8.5.
This solution was heated to 95° C. After 10 minutes the reaction started, which was monitored until the cloud point was reached after some 40 minutes. The cloud point is defined as the moment at which one drop of the precondensate, added to a large amount of water at 20° C., no longer dissolves directly but exhibits turbidity. The reaction was monitored further and every 10 minutes a sample was taken for determination of the water tolerance (WT). The reaction was stopped by cooling to room temperature upon reaching a WT of 2.3.
The WT is defined as the amount of water (in grams) which, at 20° C., can be added to 1 gram of the precondensate before the precondensate becomes turbid. The MF precondensate was filtered over a 2 μm filter before it had fully cooled. Upon reaching this WT value the precondensate is stable for more than 30 days and can be transported without further reaction.
An MF precondensate with a solids content of 55 wt. % and an F/M molar ratio of 1.7 was obtained.
By spray-drying an MF precondensate can be obtained that is stable for an indefinite period of time.

### EXAMPLE II

To prepare an MF precondensate 300 g of a formaldehyde comprising stream was added to a 2.0 L reactor. The pH of the formaldehyde comprising stream was set at 7.9 by means of NaOH and 547 g of a melamine comprising aqueous stream was added.

The melamine comprising aqueous stream was separated directly after the stripper of a melamine plant.
The melamine comprising aqueous stream comprised 79 wt. % melamine and 21 wt. % water and the formaldehyde comprising stream comprised 55.4 wt. % formaldehyde and 44.6 wt. % water.
The pH was subsequently brought to 7.9.
This solution was heated to 60° C. After 10 minutes the reaction started, which was monitored until the cloud point was reached after some 45 minutes. The cloud point is defined as the moment at which one drop of the precondensate, added to a large amount of water at 20° C., no longer dissolves directly but exhibits turbidity. The reaction was monitored further until a total reaction time of 300 minutes was reached. An MF precondensate with an F/M molar ratio of 10 was obtained. The precondensate is stable for more than 30 days and can be transported without further reaction.

1. Process for the production of an aqueous stream comprising melamine and aldehyde, characterized in that a melamine comprising aqueous stream is contacted with an aldehyde comprising stream, the melamine comprising aqueous stream originating from a melamine plant.

2. Process for the production of an aqueous stream comprising melamine, urea and aldehyde, characterized in that a melamine comprising aqueous stream and a urea comprising stream are contacted with an aldehyde comprising stream, the melamine comprising aqueous stream originating from a melamine plant.

3. Process according to claim 1, characterized in that the melamine comprising aqueous stream is purified prior to being contacted with the aldehyde comprising stream.

4. Process according to claim 2, characterized in that the urea comprising stream originates from a urea plant

5. Process according to claim 1, characterized in that the aldehyde is formaldehyde.

6. Process according to claim 1, characterized in that the melamine and formaldehyde comprising aqueous stream has an F/M ratio of between 0.5 and 20.0.

7. Process according to claim 2, characterized in that the aqueous stream comprising melamine, urea and aldehyde has an F/(NH2)2 ratio of between 0.5 and 5.0.

8. Process according to claim 1, characterized in that the formaldehyde comprising stream is a gaseous stream originating from a formaldehyde plant.

9. Process according to claim 1, characterized in that the melamine comprising aqueous stream comprises between 5 and 50 wt. % water.

10. Process according to claim 1, characterized in that the melamine comprising aqueous stream originates from the stripper of the melamine plant.

11. Process according to claim 1, characterized in that the contacting of the melamine comprising aqueous stream, and optionally the urea comprising stream, with the formaldehyde comprising stream takes place in the formaldehyde plant.

12. Process according to claim 11, characterized in that the contacting of the melamine comprising aqueous stream with the formaldehyde comprising stream takes place in an absorption column in the formaldehyde plant.

13. Process according to claim 1, characterized in that the aqueous stream comprising melamine and aldehyde is purified by filtration.

14. Process for optimizing a melamine plant that comprises a melamine synthesis section, comprising a reactor, quench and stripper, and a recovery section, in which the melamine is purified, characterized in that the capacity of the melamine synthesis section is increased more than the capacity of the recovery section and with a part of a melamine stream from the melamine synthesis section being dosed as melamine comprising aqueous stream to a process according to claim 1.

15. Plant for the preparation of a melamine and formaldehyde comprising aqueous stream, comprising a melamine synthesis section in which a melamine comprising aqueous stream is formed and optionally a recovery section, in which the melamine is purified, characterized in that the plant comprises a combination section in which the melamine comprising aqueous stream is contacted with a formaldehyde comprising stream so that the aqueous stream comprising melamine and formaldehyde is formed and means for the transport of the formaldehyde comprising stream to a combination section and for the transport of the melamine comprising aqueous stream from the melamine plant to the combination section.

16. Plant for the preparation of an aqueous stream comprising melamine, urea and formaldehyde, comprising a melamine synthesis section in which a melamine comprising aqueous stream is formed and optionally a recovery section, in which the melamine is purified, characterized in that the plant comprises a combination section in which the melamine comprising aqueous stream is contacted with a urea comprising stream and a formaldehyde comprising stream so that the aqueous stream comprising melamine, urea and formaldehyde is formed and means for the transport of the formaldehyde comprising stream and the urea comprising stream to a combination section and for the transport of the melamine comprising aqueous stream from the melamine plant to the combination section.

17. Plant according to claim 16, characterized in that the plant also comprises a urea synthesis section, in which a urea comprising stream is formed, and optionally a recovery section in which compounds other than urea are wholly or partially removed from the urea comprising stream, characterized in that the urea comprising stream that is added to the combination section originates from the urea synthesis section.
